(19) United States
(12) Patent Application Publication
(10) Pub. No.: US 2020/0222815 A1
(43) Pub. Date: Jul. 16, 2020

(54) Fantasy Sports Playoff Grouping

(71) Applicants: Darryl Baldwin, Atlanta, GA (US); Charles Taylor, Stockbridge, GA (US); Jerry Stanton, Norcross, GA (US); Eric Nicoll, Lawrenceville, GA (US); Eric Fears, Atlanta, GA (US)

(72) Inventors: Darryl Baldwin, Atlanta, GA (US); Charles Taylor, Stockbridge, GA (US); Jerry Stanton, Norcross, GA (US); Eric Nicoll, Lawrenceville, GA (US); Eric Fears, Atlanta, GA (US)

(21) Appl. No.: 16/700,929

(22) Filed: Dec. 2, 2019

Related U.S. Application Data
(63) Continuation-in-part of application No. 15/594,797, filed on May 15, 2017, now abandoned.
(60) Provisional application No. 62/336,716, filed on May 15, 2016.

(51) Int. Cl. A63F 13/828; A63F 13/35

(52) U.S. Cl. CPC A63F 13/828; A63F 13/35

(57) ABSTRACT

Multiple contestants engage in a fantasy sports game across a total of Y rounds of fantasy play which are indexed as rounds y={1, 2, . . . Y}. N and Y are integers greater than two. For each y^{th} round of the total Y rounds corresponding to Y playoff rounds in a football league: a) exactly one winning fantasy team per group in the respective y^{th} round is determined, each group comprising no more than N fantasy teams selected from either an immediately preceding (y−1)^{th} round or from an initial upload of no more than N^{Y} fantasy teams for an initial (y=1)^{th} round; and b) advancing to a next subsequent round only the winning fantasy teams. Further in the method, a grand prize is tangibly awarded to a contestant associated with the fantasy team determined to be the winner of the group in a final (y=Y)^{th} round.

### PRIORITY CLAIM

This application is a continuation-in-part of U.S. patent application Ser. No. 15/594,797 filed on May 15, 2017, and further claims priority through that parent application to provisional U.S. patent application Ser. No. 62/336,716 filed on May 15, 2016.

### TECHNOLOGICAL FIELD

The described invention relates to online fantasy sports and specifically to fantasy American football in which contestants select actual live players of the sport to populate their respective virtual (fantasy) teams and where the performance of the fantasy teams against each other within the fantasy football contests depends upon the selected players' performance while playing their sport on-field.

### BACKGROUND

Online fantasy sports are known in the art. In general, the underlying sport is a team sport for which there are actual teams competing against one another in live on-field play. Fantasy sports contestants operate from the position of a team manager and populate their fantasy team by ‘drafting’ virtual representations of the live players that currently play on the actual teams that compete in the underlying team sport. Performance of the fantasy team is directly related to the actual on-field performance of the actual players who are represented virtually on a given fantasy team and selected for play by the fantasy sports contestant managing the fantasy team. For example, if actual running back player AB scores a 6-point touchdown in live on-field play of American football in a current week, any fantasy football team that drafted a virtual representation of player AB onto that team and selected player AB for its line-up to play for the current week would receive a certain number of fantasy points to reflect that touchdown which the actual player AB scored in live on-field play. These basics closely follow the earliest fantasy sports contests which date to about 1962, which at that time appear to have been restricted to in-person fantasy sports leagues.

Fantasy sports have experienced explosive growth after adopting online play, and a more complex scoring system accounts for the much larger number of teams competing against one another in current internet-based fantasy sports platforms. The largest and most successful fantasy football leagues have tens or even hundreds of thousands of fantasy teams in a pool where the highest total fantasy team score across the entire season determines the overall winning team. Even so-called daily fantasy sports contests have each fantasy team competing against a field of hundreds or thousands of other fantasy teams. While these adaptations may accommodate a huge number of fantasy teams, much of the excitement of head-to-head/one-on-one competition is lost when the prevailing team is the one that out-scores hundreds or thousands of other fantasy teams that no single fantasy team contestant can track let alone plot his/her starting line-up to account for opponent's strengths and weaknesses. Embodiments of these teachings overcome these shortfalls by strictly limiting the number of teams any given fantasy team will compete against in any given contest without sacrificing the scaling advantages that online fantasy gaming offers.

### SUMMARY

In a first embodiment of these teachings there is a method comprising, for each y^{th} round of a total Y rounds of fantasy play corresponding to Y playoff rounds in fantasy American football: determining exactly one winning fantasy team per group in the respective y^{th} round, each group comprising no more than N fantasy teams selected from either an immediately preceding (y−1)^{th} round or from an initial upload of no more than N^{Y} fantasy teams for an initial (y=1)^{st} round, where N and Y are each integers greater than two and y indexes as {1, 2, . . . Y}; and advancing to a next subsequent round only the winning fantasy teams. The method further comprises tangibly awarding a valuable (grand) prize to a contestant associated with the fantasy team determined to be the winner of the group in a final (y=Y)^{th} round.

In a second embodiment of these teachings there is a method of operating a fantasy football bracket comprising:
a) uploading from multiple contestants a maximum of N^{Y} fantasy teams, each uploaded fantasy team comprising an initial lineup comprising fantasy players corresponding to live players of an underlying football league, where N and Y are each integers greater than two and Y equals a number of rounds of play for the underlying football league;
b) in an initial y=1 round of the Y rounds where y indexes as {1, 2, . . . , Y}:
   grouping the uploaded fantasy teams into no more than N^{(Y-1)} groups, each group having a maximum of N fantasy teams;
   ascribing to each of the uploaded fantasy teams a score based on on-field performance, during a round of the football league corresponding to the initial first round y=1, of the live players corresponding to the fantasy players of the initial lineup of the respective fantasy team;
   for each respective one of the no more than N^{(Y-1)} groups, comparing the ascribed scores of only the fantasy teams within the respective group and from the comparing selecting a group-specific winning fantasy team for advancement to the next subsequent (y+1)^{th} round;
c) in each next subsequent (y+1)^{th} round of the Y rounds which hereinafter is the current y^{th} round, until a final (y=Y)^{th} round:
   grouping only the fantasy teams selected for advancement to the current y^{th} round into no more than N^{(Y-y)} groups, each group having a maximum of N teams;
   uploading from the contestants associated with the fantasy teams selected for advancement to the current y^{th} round an updated y^{th} round lineup for the respective fantasy team, each updated lineup comprising fantasy players and field positions corresponding to live players and field positions of the football league that were not eliminated during the previous (y−1)^{st} round;
   ascribing to each of the fantasy teams of the current y^{th} round a score based on the on-field performance, during a round of the football league corresponding to the current y^{th} round, of the live players corresponding to the fantasy players in the updated y^{th} round lineup of the respective fantasy team;
   for each respective one of the no more than N^{(Y-y)} groups, comparing the ascribed scores of only the fantasy teams within the respective group and from the comparing selecting a group-specific winning fantasy team for advancement to the next subsequent (y+1)^{th} round;
d) in the final (y=Y)^{th} round:
   grouping only the fantasy teams selected for advancement to the final (y=Y)^{th} round into one final-round group;
   ascribing to each of the fantasy teams of the final (y=Y)^{th} round a score based on the on-field performance, during a round of the football league corresponding to the final (y=Y)^{th} round, of the live players corresponding to the fantasy players in a final-round lineup of the respective fantasy team;
   comparing the ascribed scores of the fantasy teams within the final-round group and from the comparing selecting a champion fantasy team; and
e) tangibly awarding a monetary grand prize to the contestant associated with the selected champion fantasy team.

In certain non-limiting embodiments, a monetary prize is tangibly awarded to each and every contestant associated with a fantasy team that advances beyond the initial y=1^{st} round of play, and no others. In this regard there may be interim monetary prizes that are progressively higher in progressively later rounds of play. In some embodiments parts a), b), c) and d) above are implemented by one or more computers that upload the maximum of N^{Y} fantasy teams from the multiple contestants via the internet; and part e) is implemented by personally presenting a valid bank draft in the amount of the monetary grand prize to the contestant associated with the selected champion fantasy team. In a preferred embodiment only one group-specific winning fantasy team is selected from each of the groups of each respective y^{th} round for advancement to the next subsequent (y+1)^{th} round; and at least the one final-round group has exactly N fantasy teams. Preferably, prior to the initial y=1 round a monetary entry fee per fantasy team is received from the multiple contestants. In certain embodiments across each of the total Y rounds, a monetary prize is awarded to each of the contestants associated with each of the group-specific winning fantasy teams that are selected for advancement, and this tangibly awarding may be performed by presenting to the respective contestant a valid bank draft or electronically transferring funds to a bank or institutional account designated by the respective contestant. The method may be executed across multiple fantasy football brackets and preferably when there are multiple brackets operated in parallel there is no more than one bracket that has less than the maximum of N^{Y} fantasy teams.

These and other aspects are detailed below with particularity.

### BRIEF DESCRIPTION OF THE DRAWINGS

FIG. 1A is a diagram illustrating play for one group having a maximum of N^{(Y-y)} fantasy teams in one round y of play according to an embodiment of these teachings, where there are a total of Y rounds of play and y={1, 2, . . . Y}.

FIGS. 1B and 1s a diagram continues the FIG. 1A example embodiment but illustrating play for all N^{(Y-y)} fantasy groups in round y of play.

FIG. 2A is a diagram illustrating competition and elimination for the initial round y=1 of Y=4 rounds of play in which there is one winning fantasy team from each of N^{(Y-1)}=4096 groups each with N=16 fantasy teams, according to an example embodiment.

FIG. 2B continues from FIG. 2A to round y=2, and illustrates competition and elimination in which there is one winning fantasy team from each of N^{(Y-2)}=256 groups each with N=16 fantasy teams that are formed from the 4096 winning fantasy teams from FIG. 2A, according to an example embodiment.

FIG. 2C continues from FIG. 2B to round y=3, and illustrates competition and elimination in which there is one winning fantasy team from each of N^{(Y-3)}=16 groups each with N=16 fantasy teams that are formed from the 296 winning fantasy teams from FIG. 2B, according to an example embodiment.

FIG. 2D continues from FIG. 2C to the final round y=4, and illustrates competition and elimination to resolve one overall winning fantasy team from N^{(Y-4)}=1 group of N=16 fantasy teams that are formed from the 16 winning fantasy teams from FIG. 2C, according to an example embodiment.

FIG. 3 is a schematic diagram illustrating progression in time for one ‘bracket’ that begins with 65,536 fantasy teams through the four rounds of play detailed at FIGS. 2A-D and summarizing fantasy team elimination and prize awards to winning teams, according to an example embodiment.

FIG. 4 is a process flow diagram illustrating certain aspects of these teachings from the perspective of a central server or group of networked servers that implement the fantasy sports play described herein, in one or multiple concurrent brackets each with a maximum N^{Y} fantasy teams participating in the initial y=1 round of fantasy play.

FIG. 5, divided among two drawing sheets as FIG. 5A and FIG. 5B, is similar to FIG. 4 but illustrating a more particularized flow diagram in accordance with certain non-limiting embodiments.

FIG. 6 is a high level schematic block diagram showing an environment in which these teachings may be practiced and certain components of a server suitable for practicing these teachings.

### DETAILED DESCRIPTION

American football is used in the description below as the underlying sport, which may be professional, collegiate, high school or otherwise. Unless otherwise specified, the term football as used herein refers to American football. Embodiments of these teachings are particularly adapted for playoffs during which certain football teams are progressively eliminated during each playoff rounds from further playoff contests; for example in a quarter-final playoff round of American football with 8 teams competing, 4 of those 8 teams will be eliminated in that quarter-final playoff round and only the remaining 4 teams will compete in the next subsequent semi-final playoff round.

The essentials of player selection and scoring for fantasy football play are known in the art and so are only summarized here. In general a contestant chooses his/her fantasy team by selecting current (live) players from actual football teams whose performance in on-field play is reflected as points for the fantasy team on which that live player is represented and selected for fantasy play. There are various regimens known in the art to determine such fantasy team scoring, and Tables 1-2 below are a non-limiting example of a scoring regimen that may be used for fantasy football. The particular scoring regimen can vary from this example so long as it is pre-defined for the fantasy play. Embodiments of these teachings are valid whether the fantasy team contestant (e.g., the person or persons or entity entering a fantasy team for competition in the fantasy league described herein) selects individual defensive players for his/her fantasy team defensive line or selects its fantasy team defensive line from among several pre-defined entire defensive team lineups (or some hybrid combination of these, for example only cornerbacks and safeties are individually selected for inclusion with an otherwise pre-defined defensive lineup).

TABLE 1
Fantasy Team Scoring based on on-field
offensive player performance.

| | On-field player performance | Fantasy team points |
|---|---|---|
| Passing | Touchdown via pass thrown | 4 |
| | Every 25 passing yards thrown | 1 |
| | 2-point conversion thrown | 2 |
| | Interception thrown | −2 |
| Rushing | Touchdown rushing | 6 |
| | Every 10 rushing yards | 1 |
| | 2-point conversion rushing | 2 |
| Receiving | Touchdown via pass received | 6 |
| | Every 10 pass reception yards | 1 |
| | 2-point conversion pass received | −2 |
| Miscellaneous | Kickoff return touchdown | 6 |
| Offense | Punt return touchdown | 6 |
| | Fumble recovered for touchdown | 6 |
| | Fumble turnover | −2 |
| Kicking | Field goal made (50+ yards) | 5 |
| | Field goal made (40-49 yards) | 4 |
| | Field goal made (0-39 yards) | 3 |
| | Point after touchdown made | 1 |
| | Field goal missed (any distance) | −1 |

TABLE 2
Fantasy Team Scoring based on on-field
defensive player performance.

| | | Fantasy team |
|---|---|---|
| | On-field player performance | points |
| Defensive | Kickoff returned for touchdown | 6 |
| Touchdowns | Punt returned for touchdown | 6 |
| | Interception returned for touchdown | 6 |
| | Fumble returned for touchdown | 6 |
| Miscellaneous | Blocked punt or field goal returned for | 6 |
| Defense | touchdown | |
| | Interception | 2 |
| | Fumble recovered | 2 |
| | Blocked punt, point after touchdown | 2 |
| | or field goal | |
| | Safety | 2 |
| | Sack | 1 |

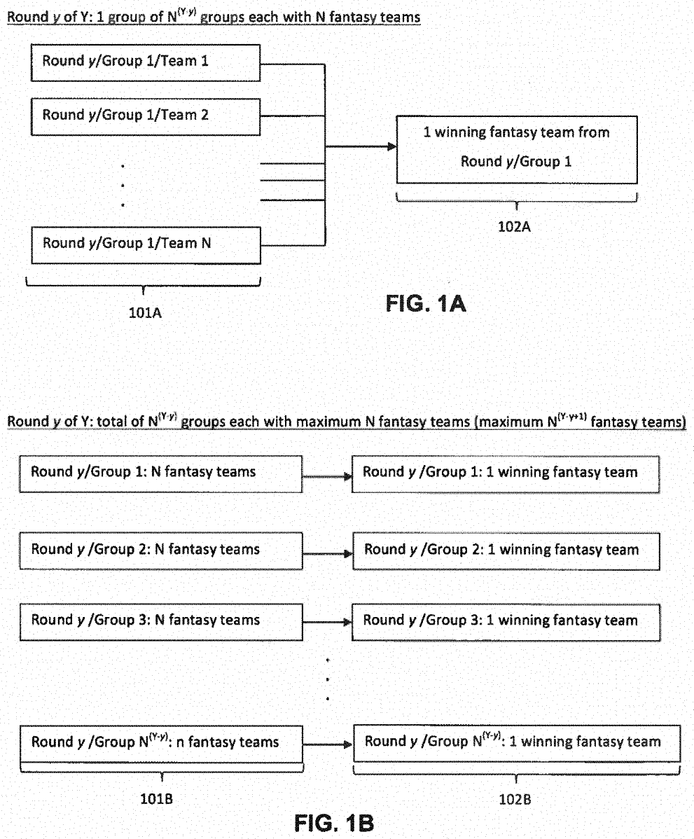

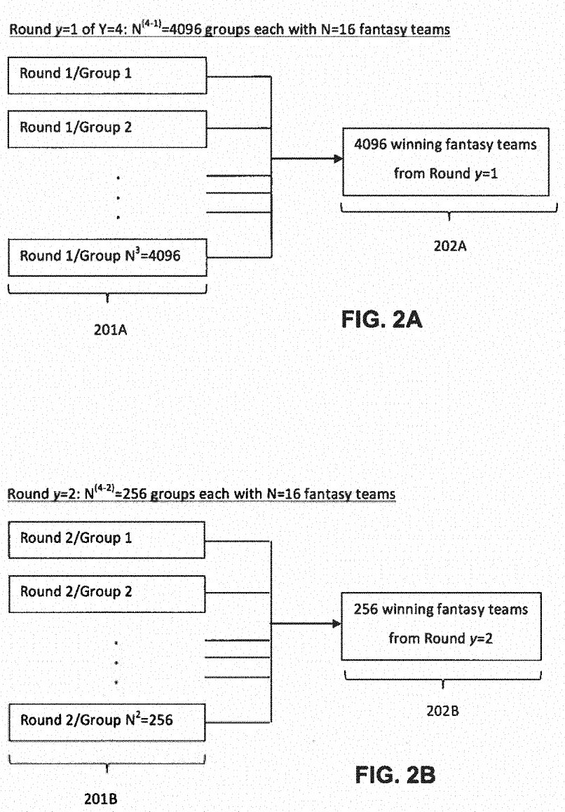

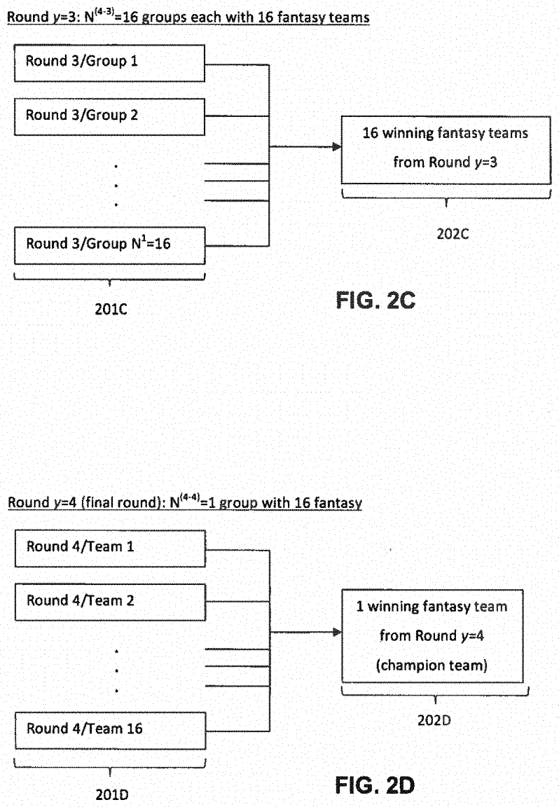

FIG. 1B and FIGS. 2A-2D provide a specific example for fantasy football according to these teachings in which there are a total of Y=4 rounds of fantasy play that begins with N^{(Y-1)}=4096 groups of fantasy teams and N=16 fantasy teams per group. FIG. 1A illustrates a single y^{th} group more generically, the total rounds of play are represented as Y which is indexed as y={1, 2, 3, . . . Y}; the maximum number of fantasy teams per group is N where N and Y are integers greater than two. Assuming all groups are fully populated with exactly N fantasy teams per group, this means that the maximum number of groups in the earliest y=1 round of the Y playoff rounds is N^{(Y-y)}=N^{(Y-1)}, and the maximum number of teams in that earliest round is N^{Y}. In later playoff rounds the number of groups, and hence the number of fantasy teams that remain to compete, is progressively reduced as fantasy teams are eliminated in each round from competition in later rounds.

FIG. 1A is a schematic diagram illustrating fantasy competition (play) for one group of fantasy teams. In any given y^{th} round each group has a maximum of N fantasy teams per group and there is a maximum of N^{(Y-y)} groups, meaning there must be a maximum of N^{(Y-y+1)} fantasy teams spread across those groups. FIG. 1A illustrates a generic round y, where there are a total of Y rounds of play with y indexing as {1, 2, 3, . . . Y}. N and Y are integers each greater than two. For the following examples assume each group is fully populated with the maximum number of N fantasy teams, meaning at the start of the first y=1 round of play there are a total of N^{Y} fantasy teams dispersed among the N^{(Y-1)} groups. This is the ideal but it may happen there are less than N^{Y} fantasy teams at the start of the initial round y=1 and some example alternatives to deal with such a not-fully-populated event are detailed below. As FIG. 1A illustrates for this single group, these N particular fantasy teams compete against only each other in round y, and from the N teams in this single group there is one winning fantasy team selected for advancement beyond this current y^{th} round. Each of these N teams compete against only others in this same group during round y as designated at column 101A, and only one winning fantasy team from this particular group will advance to the next round y+1 of play as FIG. 1A illustrates at column 102A.

In a preferred embodiment there is only a single team from each group that advances to the next round of play. In alternative embodiments detailed further below, the two or three highest scoring teams of each group 101A may advance to the next round of play. In general for each group beginning a round with N fantasy teams there will be some number of fantasy teams less than N from that group that advance to the next round of play. The examples immediately following continue assuming exactly one winning team per group per round that advances to the next round of play, except of course the final y=Y^{th} round since there is no subsequent round to which the winning team of that final round can advance.

FIG. 1B extends the FIG. 1A example to show play among all of the N^{(Y-y)} groups during a given round y. From each group of N fantasy teams that begin round y at the left as designated at column 101B, there is exactly one winning fantasy team at the right as designated at column 102B, and these are the fantasy teams that are continued in the next subsequent y+1 round of play. In some embodiments monetary or other prizes may be awarded to certain teams that do not prevail over all their same-group competitors in a given round; for purposes herein ‘winning team’ or ‘winning fantasy team’ refers to the fantasy team that advances to the next subsequent round for all y<Y rounds, and also to the team that outscores all its same-group competitors for the final y=Y round. For embodiments in which a tie is allowed to stand at the conclusion of the final y=Y round, there may be more than a single winning team for that final round in which case the prize may be split amongst them equally. Other embodiments may provide certain tiebreaker rules to forego the possibility of a tie score, for example in the event of a tie score (in any given round) the fantasy team having the earliest submission date/time for its lineup for that round will be the single winning team from its group. Other tie-breaking rules may differ, for example the fantasy team having recorded more touchdown points, or having recorded more points in the fourth quarter or in the second half, is declared the winner of an otherwise tie fantasy score.

FIGS. 2A-D illustrate an example with specific values for N and Y, but in general if one assumes one winning fantasy team per group and the maximum number N teams populating each group, each y^{th} round of play begins each given (y)^{th} round of play with a total of N^{(Y-y)} groups and a total of N^{(Y-y+1)} fantasy teams at column 101B, and from that y^{th} round of play will emerge a total of N^{(Y-y)} winning fantasy teams at column 102B that will advance to the next subsequent (y+1)^{th} round of play. Since y is an index with y={1, 2, . . . Y}, that next subsequent (y+1)^{th} round of play becomes the current y^{th} round and the above equations continue with the value of y increased by one in each subsequent round of play. Assuming as above that exactly one winning team per group advances to the next subsequent (y+1)^{th} round and each group is fully populated with exactly N fantasy teams at the start of the initial y=1 round, then it follows that each y^{th} round of play reduces the number of competing fantasy teams by a factor of N.

FIGS. 2A-D illustrate similar as FIG. 1B but illustrating each different round for four total rounds of competition/play. FIGS. 2A-D further condenses over FIG. 1B by aggregating all winning teams for a given round at the right column 202A-D into a single text box. For a total of Y=4 rounds of play, FIG. 2A illustrates the earliest (initial or first-in-time) round y=1; FIG. 2B illustrates the next successive round y=2; FIG. 2C illustrates the next successive round y=3; and FIG. 2D illustrates the final (championship or last-in-time) round y=4.

Continuing for all of FIGS. 2A-D with the above assumptions of fully populated groups and one winning team per group per round, if there are N=16 fantasy teams per group then during the first y=1 round shown at FIG. 2A there are a total of N^{(Y-y)}=16⁽⁴⁻¹⁾=4096 fantasy team groups competing in that initial y=1 round at the left column 201A. Each of these 4096 groups has exactly 16 fantasy team members and so there are N^{(Y-y+1)}16⁴=65,536 total fantasy teams competing in this y=1 first round. There is one winning fantasy team per group so the right column 202A of FIG. 2A shows 4096 total fantasy teams that will advance to round y+1 which is illustrated at FIG. 2B.

At the start of each succeeding round there remain N=16 fantasy teams per group, so during the next successive y=2 round shown at FIG. 2B there are a total of N^{(Y-y)}=16⁽⁴⁻²⁾=256 groups of fantasy teams competing at the left column 201B, meaning there are N^{(Y-y+1)}=16³=4096 total fantasy teams competing in this y=2 second round. These are the same 4096 fantasy teams that prevailed in round y=1 at column 202A of FIG. 2A that advanced for round y=2 competition at 201B of FIG. 2B, dispersed for round y=2 among 256 newly formed groups (column 201B) each with N=16 fantasy teams. One winning fantasy team in each of those 256 groups that compete in round y=2 yields a total of 256 winning fantasy teams at the right column 202B of FIG. 2B that will advance to round y=3 which FIG. 2C illustrates.

For the next successive y=3 round shown at FIG. 2C there are a total of N^{(Y-y)}=16⁽⁴⁻³⁾=16 groups of fantasy teams competing at the left column 201C, for a total of N^{(Y-y+1)}=16²=256 total fantasy teams competing in this y=3 third round. These are the same 256 fantasy teams that prevailed in round y=2 at column 202B of FIG. 2B, dispersed for round y=3 among 16 newly formed groups (column 201C) each with N=16 fantasy teams. One winning fantasy team per 16 groups in round y=3 yields a total of 16 winning fantasy teams at the right column 202C of FIG. 2C that will advance to the final round y=4 which is detailed at FIG. 2D.

The final y=4 round shown at FIG. 2D has a total of N^{(Y-y)}=16⁽⁴⁻⁴⁾=1 group of fantasy teams competing at the left column 201D, for a total of N^{(Y-y+1)}=16¹=16 total fantasy teams competing in this final y=4 round. Of course these are the same 16 fantasy teams that prevailed in round y=3 at column 202C of FIG. 2C, aggregated for round y=4 into this single final-round group (column 201D). In this final (y=Y=4)^{th} round there are exactly N=16 teams in exactly one group. There is one winning fantasy team at the right column 202D of FIG. 2D for this single group and this single team 202D is the overall winner or champion team of the original 65,532 fantasy teams.

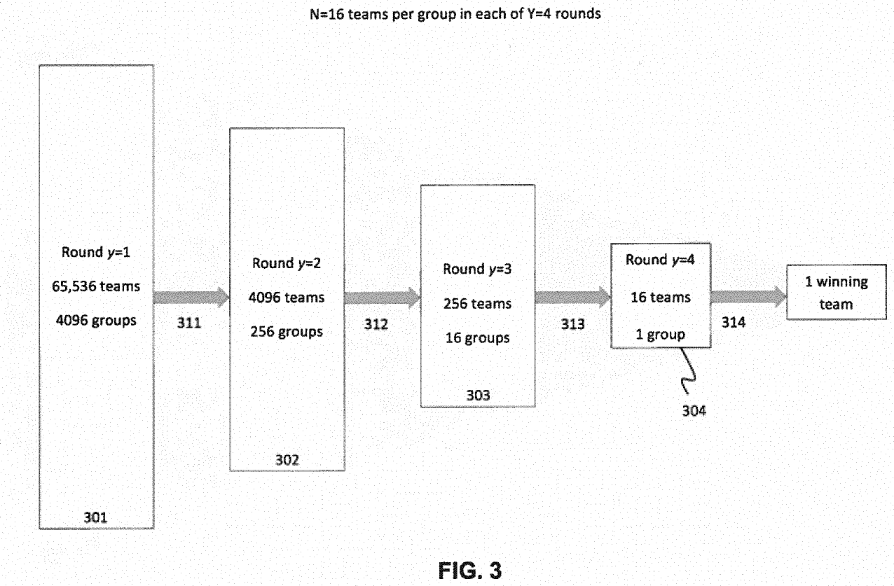

FIG. 3 is a schematic diagram summarizing the specific non-limiting example of FIGS. 2A-D in which there are N=16 fantasy teams per group and Y=4 total rounds of play. Round y=1 at block 301 shows 65,532 total fantasy teams dispersed among 4096 groups. One winning team per group from round y=1 advances at arrow 311 to the next subsequent round y=2 at block 302 in which these 4096 teams are dispersed for competition among 256 groups. The 256 winning teams from round y=2 advance at arrow 312 to the next subsequent round y=3 at block 303 in which these 256 teams are dispersed for competition among 16 groups. The 16 winning teams from round y=3 advance at arrow 313 to the next subsequent round which is the final round y=Y=4 at block 304 and from these 16 teams competing amongst each other in a single group emerges exactly one winning or champion team shown by arrow 314. With the above assumption of only one winning team per group per round, then there will always be the same number of groups in any (y+1)^{st} round as the number of teams competing in the immediately previous y^{th} round. Said another way (and assuming there is a full complement of N^{Y} fantasy teams beginning at round y=1):
each successive round reduces the number of teams and the number of groups by a factor N, as compared to the immediately previous round.

In the FIG. 3 illustration a grand (monetary) prize is awarded to the overall winning team shown by arrow 314. In one variation interim lesser prizes, preferably also monetary, are additionally awarded to each winning team that proceeds along arrow 313, and/or arrow 312 and/or along arrow 311. For the case where interim prizes are awarded in multiple rounds (for example, to fantasy teams that proceed along arrows 312 and 313), preferably the value of each interim prize is progressively higher with successive rounds. So for example if the grand prize to the overall winning/champion fantasy team following arrow 314 is one million US dollars, in a non-limiting example the 16 winning teams that advance at arrow 313 to round y=4 may each be awarded a US$25,000 prize, the 256 winning teams that advance at arrow 312 to round y=3 may each be awarded a US$2,500 prize and the 4096 winning teams that advance at arrow 312 to round y=2 may each be awarded a US$250 prize.

In certain embodiments concerning the awarding of interim monetary prizes, each winning team is awarded only the highest monetary prize it has won and no further prize for any previous interim rounds in which that team prevailed. Using the previous prize amounts $25,000, $2,500 and $250 for an example of this concept generally, if a given team is eliminated in round y=4 it would be awarded US$25,000 after its loss in round y=4 of FIG. 3 but would not additionally be awarded the lesser prize amounts US$2,500 and US$250 for its earlier playoff round fantasy competitions. In these examples any monetary prize is awarded for a given team only after that given team has either been eliminated or has won the final round of competition at block 304.

In a still further embodiment in which interim prizes are awarded, all teams that survive the initial y=1^{st} round of play win a prize. Table 3 below assumes as the above example Y=4 total rounds of play and N %16 teams per group, but the initial round y=1 is not depicted because no prizes are awarded to any of the fantasy teams that do not advance beyond that initial round of play.

TABLE 3
Example in which all teams surviving round y = 1 win a prize

| | | | | No. of |
|---|---|---|---|---|
| | No. of | No. of | No. of | teams not |
| Round of play | teams | groups | teams | advancing |
| y = 2 | 4096 | 256 | 256 | 4096 − 256 = 3840 |
| y = 3 | 256 | 16 | 16 | 256 − 16 = 240 |
| y = Y = 4 | 16 | 1 | n/a | 15 |

There are a total of 4096 teams that survive the initial round y=1 in the example of Table 3, and so each one of these in this further embodiment will be awarded a prize. Monetary prizes are progressively higher in each subsequent round of play, so for example if the entry fee per fantasy team is $75 the prize associated with round y=2 may be $150 for double the entry fee (first multiple of the entry fee), the prize associated with round y=3 may be $750 for ten times the entry fee (second multiple of the entry fee), the grand prize associated with the winning team from the final round y=Y=4 may be $1 million while other teams that compete in but do not win that final round being awarded interim prizes between that grand prize and the prize associated with round y=3. In this embodiment the 256 teams that win their respective groups in round y=2 are not awarded the $150 prize associated with that round, but each is guaranteed to win an even greater prize due to a) the prizes associated with the next round are greater than those associated with the previous round, and b) each team that survives to round y=2 is guaranteed to win a prize. That is, for every group of fantasy teams in a y^{th} round between the first/initial round and the final round, a) the winning fantasy team of that group advances to the next subsequent round and is awarded no prize for winning in that y^{th} round, and b) all other fantasy teams of that group are awarded a monetary prize despite not winning in that y^{th} round and none of them advance to the next subsequent round subsequent to that y^{th} round (e.g., they get a monetary prize and are eliminated from further competition).

In this preferred embodiment, the interim prizes are awarded to each fantasy team after said team is eliminated from competition following the first/initial round of play. Note the grand prize is not an interim prize so the championship team wins no interim prize since it was never eliminated. Generalizing from the example immediately above, each team losing at round 2 wins a first interim monetary prize equal to double the entry fee (e.g., $75) for the playoff fantasy competition, each team losing at round 3 wins a second interim monetary prize that is greater than the first interim monetary prize (e.g., ten times the entry fee), and each team losing at round 3 wins one of (N−1) graduated interim monetary prizes depending upon their rank within their respective group for round 3 (where the lowest graduated interim monetary prize is greater than the second interim monetary prize). The grand prize in this preferred embodiment is a monetary prize greater than the highest of the graduated interim monetary prizes.

Continuing with this example, assume the entry fee per team is $75. The first interim monetary prize is awarded to each of the fantasy teams that lose at round y=2 (15 per group if N=16) and each of those teams are awarded $150. The second interim monetary prize is awarded to each of the fantasy teams that lose at round y=3 (15 per group if N=16) and each of those teams are awarded $750. Each of the fantasy teams that lose at the final round y=4 (15 total fantasy teams for the single final round group if N=16) is rank ordered according to their fantasy score for that final round y=4 and awarded one of the graduated interim monetary prizes according to the following Table 4. The highest scoring fantasy team in the final round will of course be awarded the grand prize, which in this example may be $1,000,000 and is not shown in Table 4.

TABLE 4
Example graduated monetary prizes for the final round

| Fantasy score | | Graduated |
|---|---|---|
| in final round | Final round rank | monetary prize |
| 2nd highest | 2 | $100,000 |
| 3rd highest | 3 | $90,000 |
| 4th highest | 4 | $85,000 |
| 5th highest | 5 | $80,000 |
| 6th highest | 6 | $75,000 |
| 7th highest | 7 | $70,000 |
| 8th highest | 8 | $60,000 |
| 9th highest | 9 | $50,000 |
| 10th highest | 10 | $40,000 |
| 11th highest | 11 | $30,000 |
| 12th highest | 12 | $25,000 |
| 13th highest | 13 | $20,000 |
| 14th highest | 14 | $15,000 |
| 15th highest | 15 | $10,000 |
| lowest | 16 | $5,000 |

Different embodiments may implement the prizes for the final y=Y=4^{th} round differently. As above, there may be a tiebreaker rule to assure there are no tie scores for that final round, or alternatively if there is a tie score the awards for those two teams are combined and then split evenly among them; for example, a $1 million grand prize for first place plus a $100,000 highest graduated interim prize for second place would be combined and paid out equally as $550,000 to each of two teams that are tied with the highest fantasy score at the close of that final round. Progressively higher prize values for higher scoring teams in a given round, as shown by example at Table 4, may be confined to only the final round or may be employed for other rounds associated with interim monetary prizes.

In a preferred embodiment all prizes are monetary prizes but more generally any prize may be a valuable prize for which ownership is transferred to the contestant associated with the respective fantasy team. For the case of monetary (cash) prizes such ownership may be transferred by personally presenting a bank draft in the amount of the monetary prize to the contestant associated with the respective fantasy team, where such bank draft is valid and payable to that contestant or his/her designee. This may be particularly suitable for awarding of the prizes at a public event which may be publicized via broadcast or video-stream for marketing or public relations purposes. Ownership of the monetary prize may alternatively be transferred by electronically transferring the value of the monetary prize to a bank or other institutional account (e.g., brokerage, PayPal®, Venmo®, etc.) designated by that contestant for receipt of such monetary prize. [Note that where a third party governmental authority such as a tax agency requires withholding of a portion of the total value before transfer to the contestant, the amount of the monetary prize for which ownership is transferred to the respective contestant is the total of the amount transferred directly to the contestant plus the amount withheld and paid to the third party governmental authority on behalf of that contestant. This is because the withheld amount is a debit payable by the contestant but merely collected by the third party from the person or entity paying the prize.] Currency may also be presented to the contestant or his/her designee as the monetary prize and this presentment itself also represents a transfer of ownership of the currency because currency is a bearer instrument. In a preferred embodiment the contestants electronically transfer to the fantasy league operator an entry fee per fantasy team that a given contestant enrolls (for example a $75 or $150 entry fee for the entire playoff season), so electronically transferring the monetary prizes to the contestants associated with the winning fantasy teams embodies an efficient symmetry.

For non-cash prizes of tangible property such as an automobile or a house, ownership is transferred with title to that property; or for the case of tangible property such as a valuable wristwatch for which there is no title, ownership is transferred when the contestant or his/her designee takes possession of the tangible property. For intangible prizes such as exotic vacations, concerts or the theater, ownership may be transferred to the contestant when the fantasy league operator or its designee provides to that contestant or his/her designee a valid ticket or reservation (electronic or otherwise) in the name of the contestant or his/her designee for airfare, hotel, activity and/or (e.g., theater, concert, play) for example. In these implementations with non-monetary prizes, the above descriptions relating to relative value of the prizes (higher, lower) is implemented with respect to the monetary value of the prizes regardless whether the prizes themselves are monetary. In any case, the awarding of the prize is embodied as a tangible transfer of ownership to the winning person/contestant, and this transfer is tangible even if done via an electronic bank transfer since such electronic transfers are readily verifiable and accepted as transfer of ownership.

In a specific but non-limiting embodiment, each fantasy team that advances to the next subsequent (y+1)^{th} round should be re-populated with a new selection of fantasy players for that next successive round, where the newly selected fantasy players correspond to actual (live) players of the football teams that advance to the next round in the underlying football league, whether high school, college or professional. Thus the fantasy teams in each round will be populated by names corresponding to the actual players that advance in the playoffs of the underlying football league and the fantasy scoring can reflect actual player performance for the corresponding round of the underlying football league. Assuming that for FIG. 3 round y=4 corresponds to the Superbowl of the National Football League (NFL), then round y=3 corresponds to the semifinals (NFC and AFC championships), round y² corresponds to the quarterfinals (divisional round), and round y=1 corresponds to the first/initial playoff round (wildcard round). In this embodiment the fantasy team contestants would populate their fantasy teams for round y=1 with players selected from among the 8 NFL teams competing in the NFL's wildcard round; those fantasy teams advancing to round y=2 would re-constitute their fantasy teams for round y=2 and submit their lineup of players selected from only among the 8 NFL teams competing in the NFL's divisional round; the fantasy teams advancing to round y=3 would again re-constitute their fantasy teams for round y=3 and submit an updated lineup for this round listing players selected from only among the 4 NFL teams competing in the NFL's AFC/NFC championship round, and the few fantasy teams advancing to the final round y=4 would again re-constitute their fantasy team lineup for round y=4 with players selected from only among the 2 NFL teams competing in the NFL's Superbowl round.

For the above embodiments in which fantasy team lineups are re-constituted/re-populated in each successive round, there may be default rules so that fantasy teams are treated fairly in certain circumstances rather than being effectively eliminated from further competition by events beyond their control; for example if an actual player suffers an injury after being selected for a fantasy team's lineup in fantasy round y=2 but prior to the start of the actual NFL divisional round in which the actual player was to compete. Each fantasy team naming that player for its (y=2)^{th} round lineup may be awarded zero points for that player in round y=2, but certain rule alternatives may be more forgiving and award to each of those fantasy teams: a) the lowest number of fantasy points attributed to that actual player for any game across the current season of the underlying sport in which the actual player participated; or b) the number of fantasy points attributed to that actual player for the immediately preceding week of play (regular or post-season) in which that player participated.

The specific non-limiting example of FIGS. 2A-D and FIG. 3 allows for a maximum of N^{Y}=65,536 fantasy teams. This is the maximum number of fantasy teams to fully populate one ‘bracket’ and the teachings herein simply scale to additional brackets if there are additional fantasy teams to accommodate. For example, if 183,500 contestants would each like to enter a single fantasy team, the first 65,536 contestants could be allocated to a first bracket as shown at FIG. 3, the next 65,536 contestants could be allocated to a second bracket identical to that shown at FIG. 3 and operated in parallel, and the remaining 52,428 contestants could be allocated to a third bracket that is also identical to that shown at FIG. 3 and operated in parallel. In this regard FIG. 3 represents one bracket and additional brackets can be started with entry of additional fantasy teams once the current bracket is fully populated/subscribed.

For the case in which there are less than the maximum number of fantasy teams in a given bracket, that bracket is considered less than fully subscribed. In practice when there is a less than fully subscribed bracket the fantasy league operator may install ‘dummy’ fantasy teams that are generated by the operator itself to fill the bracket. If there are less than a minimum threshold number fantasy teams in a given bracket (for example, the minimum threshold may be 60%, 70% or 80% subscribed) the operator may cancel those fantasy teams from play and issue a refund of the entry fee to those canceled contestants to avoid having to fill a substantial portion of a bracket with dummy fantasy teams. Dummy teams should be selected with the same constraints as to players and salary cap as any other fantasy team, and they may be manually generated by the fantasy league operator or automatically generated by a computer algorithm. For the case in which the bracket threshold is satisfied and the operator completes the bracket with dummy fantasy teams, there are a number of ways to disperse the dummy fantasy teams among the actual non-dummy fantasy teams entered by actual contestants so those actual contestants playing the non-dummy teams do not feel at a disadvantage. In one embodiment the dummy fantasy teams may be randomly inserted among the various N^{(Y-1)} groups of fantasy teams during the earliest playoff round so that ideally the bracket would be completely filling in the first round with a combination of regular/non-dummy and dummy fantasy teams. Whether completely filled or not, any dummy fantasy team prevailing in a given round will advance to the next round the same as if it were a regular/non-dummy fantasy team contestant.

In another embodiment the actual/non-dummy fantasy teams may be clustered into a minimum number of the fantasy team groups during the first/earliest playoff round to maximize elimination of the dummy fantasy teams as early as possible. In this other embodiment there will be some and preferably most groups that include only paying contestant fantasy teams (zero non-dummy fantasy teams), at most one group with a mix of dummy and non-dummy fantasy teams, and one or more remaining groups populated with only dummy fantasy teams. Since those remaining groups would have only dummy fantasy teams the operator may provide only one dummy fantasy team as the winning team from each such remaining group to advance to the next playoff round as opposed to actually having groups in which only dummy teams compete against one another. As play progresses to subsequent rounds any advancing dummy fantasy teams would eventually be put into groups with other non-dummy fantasy teams. Preferably if there remains any dummy fantasy team or teams in the final round, the operator of the fantasy sports league will eliminate any such remaining dummy teams from competition in that final round to ensure that the overall winner of the final bracket is a paying contestant. The rules of play preferably set forth clearly for the paying contestants how dummy teams, if any, are handled during the various rounds of play.

A variation on the embodiment above having certain groups populated entirely by dummy fantasy teams is to eliminate those groups altogether. Consider an example where N=16 as the maximum number of teams per group and there are a total of Y=4 playoff rounds. A full bracket would have exactly 65,536 teams dispersed among exactly 4096 groups of exactly 16 fantasy teams each. Assume for this example there are only 57,963 fantasy teams entered by actual contestants and that this number meets the fantasy game operator's minimum threshold to run the bracket. In this variation, for the first y=1 playoff round these 57,963 fantasy teams will be dispersed among 3622 groups each having exactly 16 regular/non-dummy teams, and the remaining 11 regular/non-dummy fantasy teams could be grouped with 5 dummy fantasy teams for the 3623^{rd} group or else that 3623^{rd} group can continue with less than N=16 fantasy teams competing. For the next subsequent round y=2 there will be 3623 teams prevailing from the first round dispersed among 227 groups in which case either one group (the 227^{th}) will have less than 16 fantasy teams (preferred) or that single group can be filled with dummy teams so that every one of the 227 groups has exactly 16 fantasy teams for round y=2.

Alternatively the fantasy game operator may choose to abstain from dummy fantasy teams altogether, which in the variation example immediately above would leave group number 3623 with a total of 11 fantasy teams, all regular/non-dummy. To the extent the contestants are able to see beforehand the other fantasy teams in the group against which they will be competing in any given round, this is not preferable because those fantasy teams in group number 3623 will be perceived as having an unfair advantage for the first round as compared to all the fantasy teams in all the other 3622 groups having 16 teams each.

In any of the embodiments above in which dummy fantasy teams are deployed, the fantasy game operator may choose to purposely reduce their likelihood of success, for example by imposing an artificially low salary cap for the computer-generated player lineup selection of dummy teams or by failing to select a key player such as a quarterback for the lineup of dummy teams. It is in the fantasy game operator's interest that no dummy team become the overall winning team in round y=Y to avoid even the appearance that s/he has ‘rigged’ the contest.

The above examples assume N=16 teams per bracket and Y=4 rounds of play. Other football leagues may have a different number of playoff rounds Y which these teachings mimic in the fantasy sports regime. Examples 2 through 4 below still assume exactly one winning fantasy team per bracket and demonstrate different values for N and Y to illustrate the flexibility of the teachings herein to other football leagues. The value of N is not constrained for any given value of Y but for a more straightforward comparison examples 2-4 below choose the value of N such that the value of N^{Y} is relatively close to the N^{Y}=16⁸=65,536 maximum number of fantasy teams in the above example at FIGS. 2A-D and FIG. 3 that a bracket can handle in the earliest round of play.

Example 2: N=6, Y=6.
Round y=1: 46,656 fantasy teams dispersed among 7,776 groups.
Each successive y^{th} round reduces the number of teams and number of groups by a factor of N=6.
Round y=Y=6: N=6 fantasy teams dispersed among one group.

Example 3: N=9, Y=5:
Round y=1: 59,045 fantasy teams dispersed among 6,561 groups.
Each successive y^{th} round reduces the number of teams and number of groups by a factor of N=9.
Round y=Y=5: N=9 fantasy teams dispersed among one group.

Example 4: N=40, Y=3:
Round y=1: 64,000 fantasy teams dispersed among 1,600 groups.
Round y=2: 1,600 fantasy teams dispersed among 40 groups (each reduced by a factor of N=40 as compared to the previous y=1 round).
Round y=Y=3: N=40 fantasy teams dispersed among one group.

The examples 5-6 below dispense with the assumption of one winning team per group per round. Specifically, example 5 assumes two winning teams per group per round and example 6 assumes three winning teams per group per round, except that in these and other embodiments in which there is more than one winning team per group preferably the final y=Y round of play results in a single grand prize winning fantasy team from the single group competing in that final round of play. In these examples, each successive y^{th} round except the final y=Y round reduces the number of teams and number of groups by a factor of N multiplied by the number of winning teams per group, and by a factor of N for the final y=Y round of play.

Example 5: N=16, Y=4, two winning teams per group IN each round except y=Y:
Round y=1: N^{(Y-y+1)}=N⁽⁴⁻¹⁺¹⁾=16⁴=65,536 fantasy teams dispersed among N^{(Y-y)}=16⁽⁴⁻¹⁾=4,096 groups.
Round y=2: 2*4096=8192 fantasy teams dispersed among 512 groups.
Round y=3: 2*512=1,024 fantasy teams dispersed among 64 groups
Round y=Y=4: 2*64=128 fantasy teams aggregated into one group.

Example 6: N=16, Y=4, three winning teams per group in each round except y=Y
Round y=1: N^{(Y-y+1)}=N⁽⁴⁻⁴⁺¹⁾=16⁴=65,536 fantasy teams dispersed among N^{(Y-y)}=16⁽⁴⁻¹⁾=4,096 groups.
Round y=2: 3*4096-12,288 fantasy teams dispersed among 768 groups.
Round y=3: 3*768=:2304 fantasy teams dispersed among 144 groups
Round y=Y=4: 3*144=432 fantasy teams aggregated into one group.

Examples 5-6 make particularly clear that when there are more than one winning team per N-sized group in all but the final round of play, the final y=Y round of play encompasses a single group of more than N fantasy teams where the number of teams for the final y=Y round of play increases over N with increasing numbers of winning teams per group for the previous rounds. Specifically, the 2 winning teams per group at example 5 led to a final round group having 128 fantasy teams, and the 3 winning teams per group at example 6 led to a final round group having 432 fantasy teams. Since previous rounds had fantasy teams in groups of N=16, the final round play where they compete against some multiple of 16 may lead to some non-winning contestants resenting the gameplay structure after their loss, which is not preferable.

To enhance the user experience and to even out the competitive odds across all the various rounds of play including the final round, examples 5 and 6 above can be adapted such that in the final round there are still exactly N fantasy teams populating each of several final-round groups instead of all the remaining more-than-N fantasy teams aggregated into a single final-round group. In this case monetary prizes may be awarded to the single winning team from each of those various final-round groups and there would be no single largest-prize champion fantasy team for the overall bracket (e.g., FIG. 3) that began with a maximum of N^{Y} fantasy teams. In this variation, the final round of play for the above example 5 would begin with the same 128 remaining fantasy teams but they would be dispersed among 8 groups each with N=16 fantasy teams. Similarly, the final round of play for the above example 6 would begin with the 432 remaining fantasy teams which would be dispersed among 27 groups each with N=16 fantasy teams. In both cases there would be exactly one winning team from each of those (8 or 27) final-round groups that is awarded a monetary prize. The value of these monetary prizes can of course be adjusted to reflect the odds of winning for any given fantasy team before any play begins in the first round. Specifically, the odds of winning in the final round is 8/65,536 for example 5 with this adaptation whereas those same odds increase more than three-fold to 27/65,536 for example 6 with this adaptation, as compared to the examples stipulated above with more than N teams all accumulated into a single final-round group.

The above examples assume each fantasy round of play corresponds to a different playoff round in the underlying football league. But the rounds for fantasy playoff play does not have to exactly match all of the multiple rounds of play in the underlying football league; in these teachings there may be one or more rounds of play in the underlying sport for which there is no corresponding fantasy play. For example if the football league gameplay utilizes Y=3 playoff rounds instead of Y=4 playoff rounds the fantasy rounds may exclude the wildcard round of the professional American football playoffs. The technical effect is that embodiments of these teachings have fantasy rounds corresponding to some (more than two) or all rounds of play for a given season of the underlying football league. This aspect of these teachings differs substantially from conventional fantasy football competitions which typically have only single-round fantasy competitions (e.g., weekly fantasy football) which correspond to exactly one round of the underlying football league (regular season or playoffs) from which the winning fantasy team or teams is determined and there is no carry-over of winners from week to week or round to round.

Embodiments of these teachings are preferably implemented in an on-line Internet-based infrastructure in which the fantasy teams are selected by individual contestants at Internet-linked computer terminals such as personal computers or mobile devices such as smart-phones, tablet or laptop computers and the like on which particularized software applications are resident or accessed directly from online servers. The various team selections entered by the contestants at these various computer terminals are uploaded to the league operator's computer memory which preferably resides in a server or a group of networked servers where they are stored. Grouping of these various fantasy teams and play amongst them as detailed herein is executed via the league operator's software, which is also resident on that server or group of networked servers. Such software typically has a ‘stats feed’ that inputs the actual (live) players' performance on the field from which the fantasy teams' points are calculated and compiled.

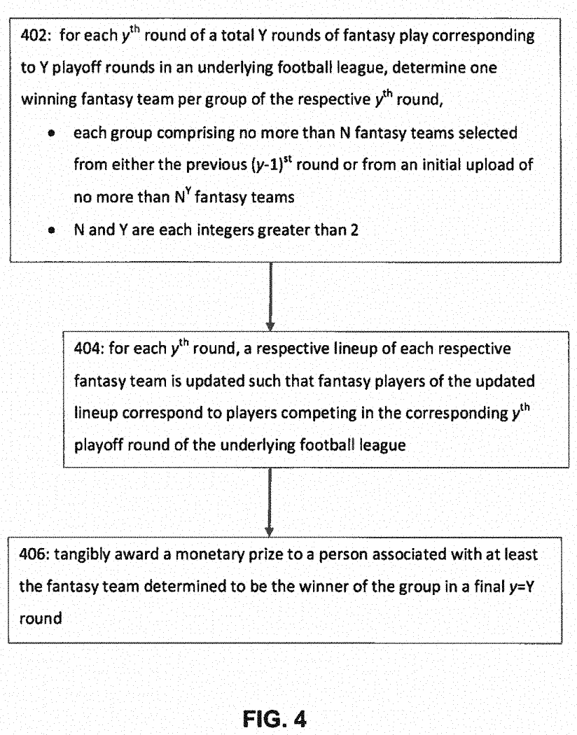

FIG. 4 is a process flow diagram illustrating some aspects of these teachings from the perspective of a central server or group of networked (Internet/cloud-based) servers that implement these teachings. In this broader overview of embodiments in which there is only one winning team per group, block 402 summarizes the rounds of play. Specifically, for each y^{th} round of a total Y rounds of fantasy play corresponding to Y playoff rounds in an underlying football league (professional/NFL, college/NCAA, etc.), there is determined one winning fantasy team per group of the respective y^{th} round. In this case each group comprises no more than N fantasy teams which are selected from either the previous (y−1)^{th} round for the case y>1, or from an initial upload of no more than N^{Y} fantasy teams for the case of the initial y=1 round. N and Y are of course integers and the value of each is at least 3.

A playoff round for the underlying football league is one contest for the case of the sport's overall championship game, or a group of contests for all other playoff rounds, which halves the total number of teams competing to be the overall champion, and in American football the various playoff contests for a given playoff round are played close in time to one another though all are not necessarily played on exactly the same date. The rounds of fantasy play correspond to these playoff rounds of the underlying football league, so that in the above example playoff round y=1 of Y=4 corresponds to the wildcard round of professional (NFL) football while playoff round y=3 of Y=4 corresponds to the conference championship playoff round that determines one winning team from each of the AFC and NFC.

Continuing with FIG. 4, there is an optional block 404 that enables the contestants to re-populate their fantasy teams progressing to the next subsequent round of fantasy play with players corresponding to the actual or live players that will be competing; those actual/live players who are on a team that is scheduled to compete in the next subsequent playoff round for the underlying football league. Where the contestant fantasy teams begin round y=1 with an initial lineup, in subsequent rounds the same team can be populated with an updated lineup since actual players are eliminated with their teams in the live football league. Specifically, block 404 summarizes that for each y^{th} round, a respective lineup of each respective fantasy team is updated such that fantasy players of the updated lineup correspond to live players competing in the corresponding y^{th} playoff round of the underlying football league. These fantasy players may be individually selected by the contestants for offensive positions such as quarterback, running back, wide receiver, etc. while there may be no option for individually selecting defensive players but instead the contestant selects from a closed group of defensive line options corresponding to the defensive line of the teams remaining in competition for that corresponding y^{th} playoff round of the underlying football league. In other embodiments individual defensive players may be selected rather than only an entire defensive line. In this regard salary caps may apply for all lineups, both initial and any updated lineups, to enhance the fantasy competitions. In some embodiments the defense portion of any initial and updated lineups may be restricted to all rounds except the final y=Y round of fantasy play, during which the N remaining contestants populate both defense and offense portions of their fantasy team lineup with individual players for the individual offensive and defensive positions which are scored in fantasy play. For example, positions such as center and nose tackle/nose guard that do not contribute to the fantasy team score may not be individually populated.

However the lineups are updated for subsequent rounds of play after the initial round y=1, in the final y=Y round there is exactly one group of exactly N fantasy teams (assuming as above exactly one winning team per group per round) from which there is a single winning team, and block 406 has a monetary prize awarded to that one winning team from that final y=Y round. As detailed more fully above, there may be additional/interim monetary prizes awarded to fantasy teams from groups in other rounds apart from the final round but FIG. 4 illustrates only the grand prize at block 406.

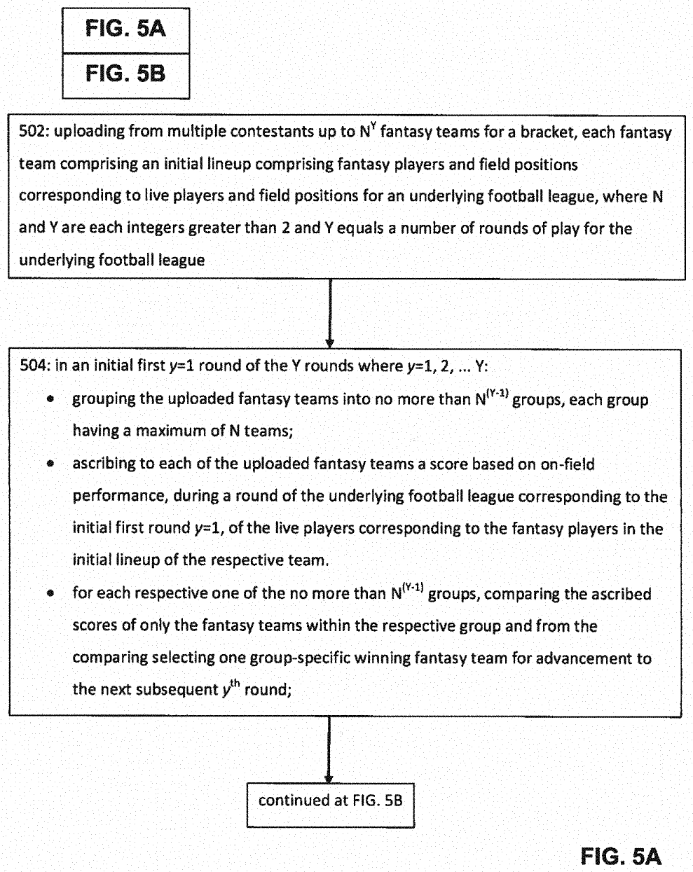

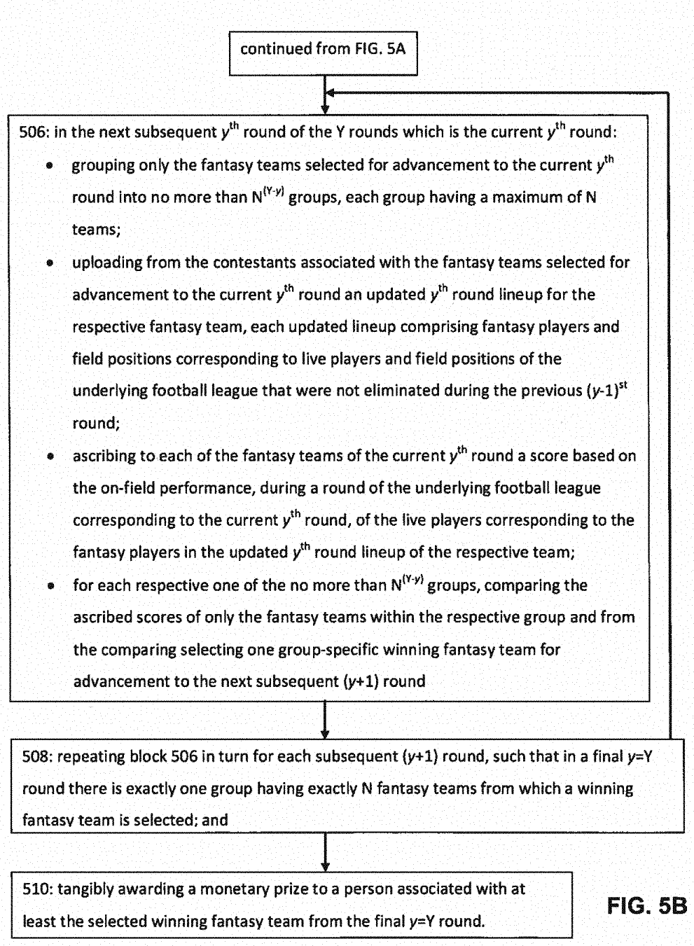

FIG. 5 is a non-limiting flow diagram similar to FIG. 4 but illustrating further particularity, where FIG. 5 is divided among two drawing sheets as FIG. 5A and FIG. 5B but forming one flow diagram. In this embodiment the upload of fantasy teams from multiple contestants occurs at block 502 of FIG. 5A. In this upload, which may occur over days or weeks or even months to fill the bracket as much as possible, up to N^{Y} fantasy teams are uploaded and each fantasy team comprises an initial lineup comprising fantasy players and field positions corresponding to live players and field positions of an underlying football league. If there are more than N^{Y} fantasy teams participating then FIG. 5 represents one bracket having a maximum of N^{Y} fantasy teams and the process of FIG. 5 is run/executed again for an additional bracket or brackets into which those further fantasy teams are placed. As with FIG. 4, for FIG. 5 each of N and Y is an integer greater than 2 and block 502 additionally specifies that Y equals a number of rounds of play for the underlying football league. In a preferred embodiment Y equals the total number of rounds of playoffs for the underlying football league, for example Y=4 corresponding to the four playoff rounds in professional American football (NFL).

Respecting the initial lineup at block 502, the fantasy players and field positions may include some individual offensive players and a defensive line selected by the contestants from a set of pre-defined defensive lines with no individual defensive line layers selectable apart from the entire defensive line as a whole, for sports in which there is a defined defensive and offensive line.

Now with the initial lineup of all the fantasy teams participating in a bracket uploaded at block 502, the first round of fantasy play is detailed at block 504. The value of y indexes as {1, 2, . . . , Y} and so this initial first round is represented as round y=1 for which block 504 details three distinct actions. Firstly the uploaded fantasy teams are grouped into no more than N^{(Y-1)} groups, each group having a maximum of N teams. As detailed above there may be dummy teams added to fill the bracket with a total of exactly N^{Y} fantasy teams for this first round in which case very group would have exactly N teams, or in other embodiments where less than N^{Y} fantasy teams participate in the initial first round of this bracket there may be one or more of these groups that are populated with less than N fantasy teams.

In either case the actual sports teams playing in the underlying football league compete on the field and from that on-field performance there is ascribed to each of the uploaded fantasy teams a score based on that on-field performance, where a) the relevant on-field performance is during a round of the underlying football league that corresponds to the initial first round y=1, and the relevant on-field performance is also b) the performance of the actual/live players corresponding to the fantasy players in the initial lineup of the respective team. This ascribed score accounts for pre-defined defensive lines for embodiments that do not allow selection of individual defensive players (assuming there are defensive fantasy points at all). For example if the fantasy scoring rules translates the performance of the Dallas Cowboys defensive line during the wildcard playoff round into 72 points, then any fantasy team selecting the Dallas Cowboys defensive line for their initial lineup in the initial first y=1 round would have 72 points of that fantasy team's total score for the initial first round arising from that on-field performance by the Cowboys defensive line. Offensive points are in addition.

Now with all the fantasy scores ascribed to all the grouped fantasy teams in the initial/first y=1 round, block 504 concludes with comparing, for each respective one of the no more than N^{(Y-1)} groups, those ascribed scores of only the fantasy teams within the respective group and from the comparing selecting one group-specific winning fantasy team for advancement to the next subsequent y^{th} round. Since this action is specific to each group there are as many fantasy teams selected for advancement to the next round as there are groups (assuming exactly one winning team per group is selected; other options are detailed above).

Block 504 deals with the initial first round in which y=1, and so the next subsequent y^{th} round increments the index y by 1 so block 506 at FIG. 5B begins with that second y=2 round. To avoid confusion in further rounds after y=2, this ‘next subsequent round’ is referred to at block 506 more generally as the current y^{th} round. The actions at block 506 are repeated for all rounds following the initial first y=1 round, until those iterations are terminated at block 508 after block 506 operates/executes on the final y=Y round, as will be detailed further below.

There are four actions at block 506 for the current y^{th} round. Recall from block 504 that only one group-specific winning fantasy team from each of the previous-round groups was selected for advancement to this current y^{th} round; these are the only fantasy teams (for this bracket) upon which block 506 operates and this is true whether block 506 is entered from block 504 or is iterated again in later rounds as the index y is incremented.

Firstly block 506 groups only those fantasy teams that were selected for advancement to the current y^{th} round on which block 506 operates, and it groups them into no more than N^{(Y-y)} groups, each group having a maximum of N teams. In some embodiments there may still be some dummy teams in these groups and for the case in which the previous round was fully filled with fantasy teams (dummy or otherwise) then each and every one of exactly N^{(Y-y)} groups will each have exactly N fantasy teams. FIG. 5 does not specifically address the variations detailed above in which there may be more than N fantasy teams in the final round of play, for example when more than one winner per group is declared for the playoff fantasy rounds prior to the final round of play.

Next block 506 accounts for the updated lineups. This may be done prior to the (re-) grouping mentioned at block 506 or after, as the fantasy teams keep the same name/identifier and only their respective lineups are updated for competition in this current y^{th} round. These updated lineups are uploaded from the contestants associated with the fantasy teams that are selected for advancement to this current y^{th} round, and since updated lineups are obtained/uploaded in all rounds after the initial lineups in the initial first y=1 round this is referred to as an updated y^{th} round lineup for the respective fantasy team. Similar to the initial lineup, each of these updated lineups comprise fantasy players and field positions corresponding to live players and field positions of the underlying football league that were not eliminated during the previous (y−1)^{st} round. Then block 506 ascribes to each of the fantasy teams of the current y^{th} round a score based on the on-field performance, during a round of the underlying football league corresponding to the current y^{th} round, of the live players corresponding to the fantasy players in the updated y^{th} round lineup of the respective team.

Finally block 506 compares, for each respective one of the no more than N^{(Y-y)} groups, the ascribed scores of only the fantasy teams within the respective group. From this comparing there is selected one group-specific winning fantasy team for advancement to the next subsequent (y+1) round immediately following this current y^{th} round.

The index y is incremented again at block 508, which returns to block 506 to operate on this next subsequent (y+1) round which is re-named at the top of block 506 as the current y^{th} round. Per block 508 this repeating of block 506 is done in turn for each subsequent (y+1) round. Eventually y is incremented to the point where y=Y and this round of play is the final y=Y round which terminates the iterative loop back into block 506 once block 508 operates on the final y=Y round. With the assumptions above of a single winning fantasy team per group per round, in that final y=Y round there is exactly one group having exactly N fantasy teams. Thus block 506 selects exactly one winning fantasy team from the final round y=Y, which block 508 identifies as the single winning fantasy team that is selected. Block 510 then has a monetary prize awarded to at least the selected single winning fantasy team from the final y=Y round. There may be additional monetary prizes awarded to the runner-up fantasy team and/or other fantasy teams in the final or other rounds of play, but FIG. 5 specifies only the grand prize awarded to the single winning fantasy team from the final y=Y round which, per block 502 corresponds to the final playoff round of the underlying football league for the case in which the different Y rounds correspond to different playoff rounds as in the above examples.

In one non-limiting embodiment each initial lineup at block 502 and each updated y^{th} lineup at block 506 comprises individual fantasy players associated with offensive field positions and a defensive line selected from among a closed set of defensive line options, such as may be stipulated by the fantasy league operator for example in a pull-down menu of options visible at the contestant's computer terminal or mobile device. Individual fantasy players cannot be substituted where there is a defensive line selection option.

For the case in which a bracket is fully subscribed then the process shown at FIG. 5 is executed using exactly N^{Y} uploaded fantasy teams, which for the initial first y=1 round are grouped at block 504 into exactly N^{(Y-1)} groups, each group having exactly N teams. In other cases it may be that less than N^{Y} fantasy teams are uploaded at block 502, in which case in one non-limiting embodiment the process comprises, for the initial first y=1 round, adding a sufficient number of dummy fantasy teams such that the uploaded fantasy teams plus the dummy fantasy teams number exactly N^{Y} which are grouped at block 504 into exactly N^{(Y-1)} groups, each group having exactly N teams.

Blocks 504 and 506 each have one winning fantasy team selected per group per round. In practice it may be that the overall fantasy score is tied among two fantasy teams in the same group of the same round. In this case ascribing the scores of the fantasy teams at these blocks can, for a case in which two or more fantasy teams in the respective group have a tied total fantasy score, further apply pre-defined tiebreaker rules such that exactly one winning fantasy team from the respective group is selected. As an example, in one embodiment for the case of a tie the tiebreaker rule can specify the team with the higher second-half score prevails, or the team with the higher fourth-quarter score, or the team with the higher number of points attributable to touchdowns prevails. In a specific embodiment there are multiple such tiebreaking rules arranged in a hierarchy such that if there remains a tie fantasy score after applying the first rule of the hierarchy the next rule is applied and so forth until the tie is broken and only one team prevails. These tiebreaking rules are applied only for those teams with the tied highest score in the group so as to prevent any team with less than the highest score from prevailing amongst the group due only to the tiebreaking rules. A further option for a tiebreaking rule is the fantasy team that submitted its lineup earlier is the winning team among those fantasy teams with the same fantasy score for a given round.

The above description of FIGS. 4 and 5 may be considered as methods according to these teachings. In other embodiments there are one or more servers that comprise at least one processor and at least one memory storing a program of executable computer instructions. In these embodiments the at least one processor is configured with the at least one memory and the program of executable instructions to cause the one or more servers to perform actions shown and described herein with reference to FIGS. 4 and 5, except the awarding of the monetary prize at blocks 406 and 510 is preferably performed via a public and well-publicized event in which the person/contestant associated with the fantasy team that wins the final y=Y round is personally handed a bank check in the amount of the grand prize (as opposed to a computer automatically transferring funds to the winning contestant's designated bank account to satisfy those blocks). In still further embodiments there is one or more computer readable memories tangibly storing a program of computer instructions that when executed by one or more processors of one or more electronic devices such as servers causes the electronic devices to perform actions according to FIGS. 4 and 5 as further detailed herein.

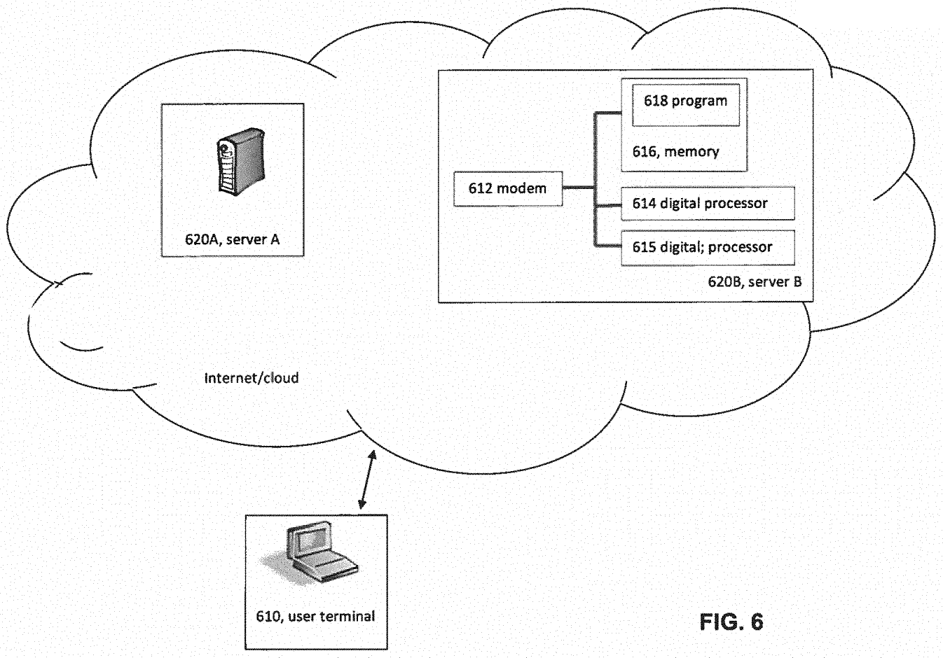

FIG. 6 is a high level diagram illustrating an exemplary environment with cloud-based servers which may embody these teachings, and more specifically a user terminal 610 (also representing a user mobile device such as a smartphone or tablet/laptop computer) which may communicate to the cloud (Internet) based servers 620A, 620B the contestants' lineup selections, and at which the contestants may receive notifications that he/she is or is not a winner of a monetary prize. Note the monetary prize is not necessarily awarded via the Internet, in some embodiments only notification of the award is done via that channel though in certain embodiments transfer of ownership of monetary cash prizes may also be performed over the Internet. In some embodiments the monetary prize is awarded in person to the contestant sponsoring/entering the single winning team, most preferably in a public ceremony where the player/contestant is presented a bank draft, to generate positive media coverage. While two servers 620A, 620B are shown, these teachings may be embodied on one server or any number of servers in communication with one another over the Internet. The servers are functionally similar in relevant part and as shown the server 620B includes a controller, such as a computer or a data processor (DP) 614 (or multiple ones of them), a computer-readable memory medium embodied as a memory (MEM) 616 (or more generally a non-transitory program storage device) that stores a program of executable computer instructions (PROG) 618, and a suitable communications interface 612 such as a modem to the communications network/Internet that will be used for sharing data stored on the different servers' memories, sharing processing power, and accepting inputs/uploads and transmitting outputs.

In general terms the server 620B can be considered a machine that reads the MEM/non-transitory program storage device and that executes the computer program code or executable program of instructions stored thereon. While the server 620B of FIG. 6 is shown as having one memory 616, in practice each server 620A, 620B may have multiple discrete memory devices and the relevant algorithm(s) and executable instructions/program code may be stored on one or across several such memories, or even across different memories of different servers.

The program 618 is assumed to include program instructions that, when executed by the associated one or more digital processors 614, enable the server/system 620A/B to operate in accordance with exemplary embodiments of this invention. That is, various exemplary embodiments of this invention may be implemented at least in part by computer software executable by the digital processor 614 of the server/system 620A/B; and/or by hardware, or by a combination of software and hardware (and firmware). Note also that one or more of the servers 620B may also include dedicated processors 615. The electrical interconnects/busses between the components at FIG. 6 are conventional and not separately labelled.

The computer readable memory 616 may be of any memory device type suitable to the local technical environment and may be implemented using any suitable data storage technology, such as semiconductor based memory devices, flash memory, magnetic memory devices and systems, optical memory devices and systems, fixed memory and removable memory. The digital processors 614, 615 may be of any type suitable to the local technical environment, and may include one or more of general purpose computers, special purpose computers, microprocessors, digital signal processors, and processors based on a multicore processor architecture, as non-limiting examples. The modem 612 may be of any type suitable to the local technical environment and may be implemented using any suitable communication technology.

Computer readable memory is non-transitory because propagating mediums such as carrier waves are memoryless. More specific examples (a non-exhaustive list) of the computer readable storage medium/memory would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), other types of optical storage devices, a magnetic storage device, or any suitable combination of the foregoing.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

We claim:

1. A method comprising:
for each y^{th} round of a total Y rounds of fantasy play corresponding to Y playoff rounds in an underlying football league:
determining exactly one winning fantasy team per group in the respective y^{th} round, each group comprising no more than N fantasy teams selected from either an immediately preceding (y−1)^{th} round or from an initial number of no more than N^{Y} fantasy teams for an initial (y=1)^{st} round, where N and Y are each integers greater than two and y indexes as {1, 2, . . . Y}; and
advancing to a next subsequent round only the winning fantasy teams;
and tangibly awarding a valuable prize to a contestant associated with the fantasy team determined to be the winner of the group in a final (y=Y)^{th} round.

2. The method according to claim 1, wherein:
the initial upload is via networked servers;
each winning fantasy team per group is determined using a fantasy team lineup for each respective y^{th} round received via the networked servers from contestants associated with the respective fantasy teams.

3. The method according to claim 2, further comprising:
restricting selection by the contestants of their respective fantasy team lineups for each respective y^{th} round to only players scheduled to compete in a corresponding y^{th} playoff round in the underlying football league.

4. The method according to claim 1, wherein the underlying football league is the National Football League (NFL) and Y=4, where
y=1 corresponds to a wildcard round,
y=2 corresponds to a divisional round,
y=3 corresponds to a conference championship round and
y=4 corresponds to a superbowl round.

5. The method according to claim 1, wherein the valuable prize is a grand prize and the method further comprising:
tangibly awarding, to each of the winning fantasy teams for the y=(Y−1)^{th} round, an interim prize that is less valuable than the grand prize.

6. The method according to claim 1, wherein the valuable prize is a monetary grand prize and:
the method is implemented by one or more computers that upload via the internet the initial no more than N^{Y} fantasy teams from multiple contestants;
except the awarding of the monetary grand prize is implemented by personally presenting a bank draft, in the amount of the monetary grand prize, to the contestant associated with the fantasy team determined to be the winner of the group in a final (y=Y)^{th} round.

7. The method according to claim 1, further comprising:
prior to the initial (y=1)^{st} round, receiving a monetary entrance fee per fantasy team from each of contestants associated with the respective N fantasy teams.

8. The method according to claim 7, further comprising:
across the total Y rounds of fantasy play, awarding a monetary prize to each of the contestants associated with the fantasy teams that advance to the next subsequent round following the initial (y=1)^{st} round.

9. The method according to claim 8, wherein each of the monetary prizes is tangibly awarded by transferring the respective monetary prize to the respective contestants by at least one of:
presenting to the respective contestant a valid bank draft; or
electronically transferring funds to a bank or institutional account designated by the respective contestant.

10. A method of operating a fantasy football bracket comprising:
a) uploading from multiple contestants a maximum of N^{Y} fantasy teams, each uploaded fantasy team comprising an initial lineup comprising fantasy players corresponding to live players of an underlying football league, where N and Y are each integers greater than two and Y equals a number of rounds of play for the underlying football league;
b) in an initial y=1 round of the Y rounds where y indexes as {1, 2, . . . , Y}:
grouping the uploaded fantasy teams into no more than N^{(Y-1)} groups, each group having a maximum of N fantasy teams;
ascribing to each of the uploaded fantasy teams a score based on on-field performance, during a round of the underlying football league corresponding to the initial first round y=1, of the live players corresponding to the fantasy players of the initial lineup of the respective fantasy team;
for each respective one of the no more than N^{(Y-1)} groups, comparing the ascribed scores of only the fantasy teams within the respective group and from the comparing selecting a group-specific winning fantasy team for advancement to the next subsequent (y+1)^{th} round;
c) in each next subsequent (y+1)^{th} round of the Y rounds which hereinafter is the current y^{th} round, until a final (y=Y)^{th} round:
grouping only the fantasy teams selected for advancement to the current y^{th} round into no more than N^{(Y-y)} groups, each group having a maximum of N teams;
uploading from at least some of the contestants associated with the fantasy teams selected for advancement to the current y^{th} round an updated y^{th} round lineup for the respective fantasy team, each updated lineup comprising fantasy players and field positions corresponding to live players and field positions of the underlying football league that were not eliminated during the previous (y−1)^{st} round;
ascribing to each of the fantasy teams of the current y^{th} round a score based on the on-field performance, during a round of the underlying football league corresponding to the current y^{th} round, of the live players corresponding to the fantasy players in the updated y^{th} round lineup of the respective fantasy team;
for each respective one of the no more than N^{(Y-y)} groups, comparing the ascribed scores of only the fantasy teams within the respective group and from the comparing selecting a group-specific winning fantasy team for advancement to the next subsequent (y+1)^{th} round;
d) in the final (y=Y)^{th} round:
grouping only the fantasy teams selected for advancement to the final (y=Y)^{th} round into one final-round group;
ascribing to each of the fantasy teams of the final (y=Y)^{th} round a score based on the on-field performance, during a round of the underlying football league corresponding to the final (y=Y)^{th} round, of the live players corresponding to the fantasy players in a final-round lineup of the respective fantasy team;
comparing the ascribed scores of the fantasy teams within the final-round group and from the comparing selecting a champion fantasy team; and
e) tangibly awarding a monetary grand prize to the contestant associated with the selected champion fantasy team.

11. The method according to claim 10, wherein:
a), b), c) and d) are implemented by one or more computers that upload the maximum of N^{Y} fantasy teams from the multiple contestants via the internet; and
e) is implemented by personally presenting a valid bank draft in the amount of the monetary grand prize to the contestant associated with the selected champion fantasy team.

12. The method according to claim 10, wherein:
only one group-specific winning fantasy team is selected from each of the groups of each respective y^{th} round for advancement to the next subsequent (y+1)^{th} round; and
the one final-round group has exactly N fantasy teams.

13. The method according to claim 10, wherein
for each y^{th} round except for the final (y=Y)^{th} round, more than one group-specific winning fantasy team is selected from each of the groups for advancement to the next subsequent (y+1)^{th} round; and
the one final-round group has more than N fantasy teams.

14. The method according to claim 13, wherein:
for each y^{th} round except for the final (y=Y)^{th} round, a same number of group-specific winning fantasy teams are selected from each of the groups for advancement to the next subsequent (y+1)^{th} round.

15. The method according to claim 10, wherein the underlying football league is the National Football League (NFL) and Y=4, where
y=1 corresponds to a wildcard round,
y=2 corresponds to a divisional round,
y=3 corresponds to a conference championship round and
y=4 corresponds to a superbowl round.

16. The method according to claim 10, further comprising:
prior to the initial y=1 round, receiving a monetary entry fee per fantasy team from the multiple contestants.

17. The method according to claim 16, further comprising:
across each of the total Y rounds, tangibly awarding a monetary prize to each of the contestants associated with each of the group-specific winning fantasy teams that are selected for advancement to the next subsequent (y+1)^{th} round.

18. The method according to claim 17, wherein each of the monetary prizes is tangibly awarded by transferring the respective monetary prize to the respective contestants by at least one of:
presenting to the respective contestant a valid bank draft; or
electronically transferring funds to a bank or institutional account designated by the respective contestant.

19. The method according to claim 10, executed across multiple fantasy football brackets parallel, in which no more than one bracket has less than the maximum of N^{Y} fantasy teams.

20. The method according to claim 19, wherein the monetary grand prize is different among at least two of the brackets.
